(19) United States
(12) Patent Application Publication
(10) Pub. No.: US 2007/0180310 A1
(43) Pub. Date: Aug. 2, 2007

(54) MULTI-CORE ARCHITECTURE WITH HARDWARE MESSAGING

(75) Inventors: William M. Johnson, Austin, TX (US); Jeffrey L. Nye, Austin, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS, INC., Dallas, TX (US)

(21) Appl. No.: 11/627,786

(22) Filed: Jan. 26, 2007

Related U.S. Application Data
(60) Provisional application No. 60/764,497, filed on Feb. 2, 2006.
(60) Provisional application No. 60/764,533, filed on Feb. 2, 2006.

(51) Int. Cl. G06F 11/00

(52) U.S. Cl. 714/12

(57) ABSTRACT

Disclosed herein are a system and method for designing digital circuits. In some embodiments, the digital circuits include processors having dedicated messaging hardware that enable processor cores to minimize interrupt activity related to inter-core communications. The messaging hardware receives and parses any message in its entirety prior to passing the contents of the message on to the digital circuit. In other embodiments, the digital circuit functionalities are partitioned across individual cores to enable parallel execution. Each core may be provided with standardized messaging hardware that shields internal implementation details from all other cores. This modular approach accelerates development and testing, and renders parallel circuit design to more efficiently attain feasible speedups. These digital circuit cores may be homogenous or heterogeneous.

### CROSS-REFERENCE TO RELATED APPLICATIONS

This application claims the benefit of Provisional Application Ser. No. 60/764,533 filed Feb. 2, 2006, titled “Improved Protocol Processor Architecture for Multi-Mode Wireless Modem,” and No. 60/764,497 filed Feb. 2, 2006, titled “Application-Specific Multi-Core Development Method,” which are hereby incorporated by reference herein.

### BACKGROUND

For each new processor generation, gate delay is reduced and the number of transistors in a constant area increases. The result is approximately two times the performance at roughly the same cost as the previous generation of processors. However, the future of this trend faces certain obstacles. New micro-architectural ideas are scarce, global interconnects are too slow and costly to allow much flexibility, and scaling is approaching limits. Improvements in pipelining, branch prediction, instruction-level parallelism (“ILP”), and caching are now at a point of diminishing or no returns. Wire dimensions do not scale with transistors, and the reach of wires grows smaller with each generation due to requirements for constant-speed communication across a constant area. Leakage currents are approaching the order of switching currents, thus smaller transistors approach a gate-source-drain short circuit.

One proposed response to these design challenges is to design a system with parallel processors. The frequency and performance of each processor core is roughly the same or a little less than previous processor generations; however, the requirements for core-to-core communications are more relaxed, leading to less overall leakage and power. Processor core-to-core communication runs closer to “off chip” speeds than “within-core” speeds, meaning that global wiring is not stressed. The result is roughly two times the performance at roughly equal the cost as the prior generation. One problem with running large numbers of parallel processors is Amdahl's Law. Amdahl's Law states that the speedup of a program using multiple processors in parallel is limited by the sequential (non-parallelizable) fraction of the program. Nonetheless, speedup can be achieved, and it is desirable to provide an efficient means for achieving the maximum feasible speedup.

### SUMMARY

The problems noted above are solved in large part by a system and method for designing digital circuits. In some embodiments, the digital circuits include processors having dedicated messaging hardware that enable processor cores to minimize interrupt activity related to inter-core communications. The messaging hardware receives and parses any message in its entirety prior to passing the contents of the message on to the digital circuit. In other embodiments, the digital circuit functionalities are partitioned across individual cores to enable parallel execution. Each core may be provided with standardized messaging hardware that shields internal implementation details from all other cores. This modular approach accelerates development and testing, and renders parallel circuit design to more efficiently attain feasible speedups. These digital circuit cores may be homogenous or heterogeneous.

### BRIEF DESCRIPTION OF THE DRAWINGS

For a detailed description of various disclosed embodiments, reference will now be made to the accompanying drawings in which:

FIG. 1 shows an illustrative integrated circuit device;

FIG. 2 shows an illustrative embodiment of a parallel processing system;

FIG. 3 shows an illustrative embodiment of control and data flow in the system;

FIG. 4 shows an illustrative embodiment of message scheduling and input data;

FIG. 5 shows an illustrative embodiment of an overview of the address and data buses;

FIG. 6 shows a flowchart according to one embodiment;

FIG. 7 shows a more detailed flowchart in accordance with one embodiment; and

FIG. 8 shows an illustrative embodiment of the system of nodes that connect with memory.

### NOTATION AND NOMENCLATURE

Certain terms are used throughout the following description and claims to refer to particular system components. As one skilled in the art will appreciate, companies may refer to a component by different names. This document does not intend to distinguish between components that differ in name but not function. In the following discussion and in the claims, the terms “including” and “comprising” are used in an open-ended fashion, and thus should be interpreted to mean “including, but not limited to . . . . ” Also, the term “couple” or “couples” is intended to mean either an indirect or direct electrical connection. Thus, if a first device couples to a second device, that connection may be through a direct electrical connection, or through an indirect electrical connection via other devices and connections.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to suggest that the scope of the disclosure, including the claims, is limited to that embodiment.

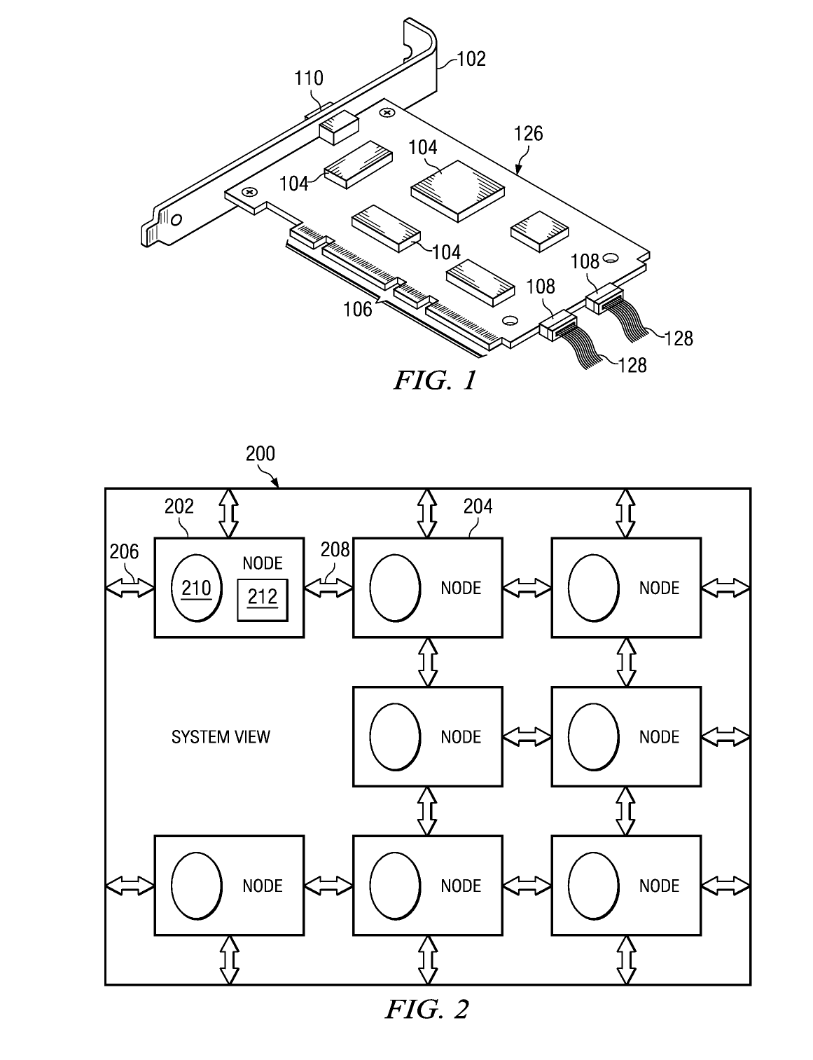

FIG. 1 shows a typical expansion card 126 for a computer, an illustrative example of integrated circuit device usage that most people would be familiar with. The expansion card 126 includes numerous integrated circuit devices 104 on a printed circuit board with a bracket 102 and an expansion slot connector 106 that fit the standard expansion form factor for a desktop computer. An external connector 110 and additional cable connectors 108 may be provided to connect (via ribbon cables 128) the card 126 to additional signal sources or destinations. The integrated circuit devices and the connectors are interconnected via conductive traces on the printed circuit board to implement the desired functionality (such as, a sound synthesis card, a graphics rendering card, a wireless network interface, etc.). The traces transport power and communications to and from and between the integrated circuit devices.

FIG. 2 shows an overview of an illustrative parallel processing system architecture that may be employed by one or more of the integrated circuit devices 104. System 200 contains numerous nodes 202-204 that operate in parallel. Each node 202 contains a processor (or core) 212 which, in some embodiments, is a general purpose processor programmed with firmware to perform only one function. Cores 212 may be homogeneous (i.e., each having a common instruction set) or heterogeneous (i.e., one or more having a different instruction set). As the development and testing of the integrated circuit device progress, each core can be individually updated or replaced without impacting the design of the other cores. To enable this modularity, each node 202 also contains standardized messaging hardware 210 which is designed to receive messages intended for the core 212 on the node 202. The messaging hardware 210 parses any message intended for the node 202 prior to passing the message on to the core 212. This hardware-level parsing enables the core 212 to continue processing its current tasks while the messaging hardware 210 receives the message. Once the message is entirely parsed by the messaging hardware 210, the messaging hardware 210 routes the completed message to the core 212 for action. The nodes are coupled via one or more interconnects 208. The interconnects 208 may be provided in any interconnect topology, including shared fabrics or private, point-to-point interconnects.

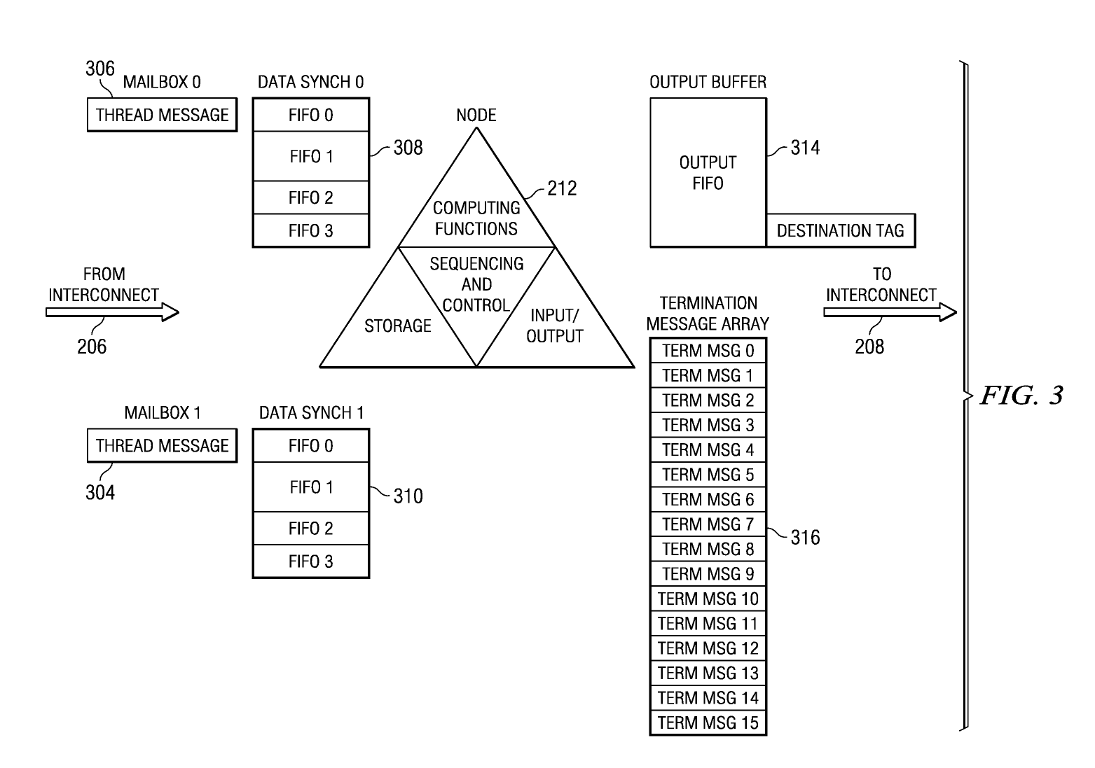

FIG. 3 shows an overview of the data flow within a given node 202 in accordance with some embodiments. The messaging hardware 210 includes mailboxes 304-306, input buffers (Data Synch RAM) 308-310, an output buffer 314, and a termination message array 316. The messaging hardware 210 implements the protocols associated with messages and data transfers between the interconnects, the memory buffers, and the local core 212.

Messaging hardware 210 contains addressing logic for each mailbox, input buffer, and output buffer. The mailboxes, input buffers, and output buffers may take the form of allocated space in a single memory array, in which case the addressing logic generates read and write pointers to enable access to the appropriate memory locations. The messaging hardware further includes one or more programmable registers for specifying a node ID and control parameters that enable the hardware decoding of message headers.

Mailboxes 304-306 receive control messages, e.g., messages that schedule node operations and configure execution threads. The memory buffers 308-310 are each associated with addressing logic for buffering data transfers from up to four possible input sources. Thus separate paths are provided for control messages and data transfers to avoid various control/data flow hazards. With separate paths provided in this manner, the memory buffers can even receive data before the mailboxes receive the associated control messages.

As will be discussed further below, a given node may include a separate set of messaging hardware (mailbox and input buffer) for each physical execution thread. However, the operation of each set of messaging hardware can be the same, i.e., independent of the thread to which the messaging hardware is dedicated.

For each outgoing interconnect 208, a corresponding output buffer 314 buffers data for transmission via the interconnect. The output buffer operates in accordance with a given interface protocol, e.g., the output buffer waits for an acknowledge from the interface protocol before reading the next message. Moreover, when transmitting messages, the output buffer ensures that the current read pointer does not increase past the write pointer. When appropriate, the output buffer can also send one or more termination messages from the termination message array 316. For example, when an execution thread terminates, the output buffer 314 completes transmitting all valid data from that thread and sends an “End of Source” message, as identified by an output tag from the terminating execution thread.

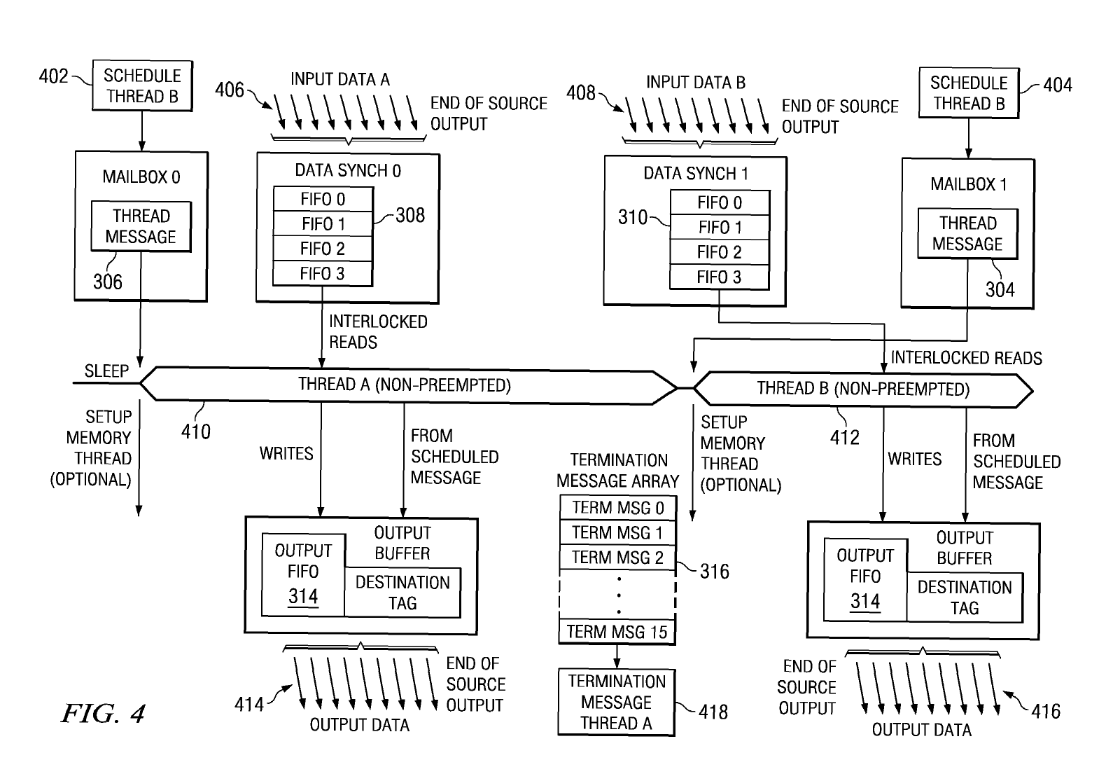

FIG. 4 shows one example to illustrate certain benefits of messaging hardware 210. In this example, a control message 402 is received in mailbox 306. The control message 402 is a “scheduling” message to initiate an execution thread, “Thread A”, and once the message is received, mailbox 306 triggers an interrupt to have Thread A 410 run in the core 212 and read the control message. Optionally, Thread A 410 may configure an output buffer to store and forward output data as it is generated.

Subsequently, input data 406 for Thread A is received in input buffer 308 and retrieved by Thread A 410 for processing. In this example, Thread A's input data 406 is followed by input data 408 for Thread B 412. Input data 408 is received in input buffer 310 for eventual retrieval by Thread B. A control message 404 for control B follows the input data 408 and is received in mailbox 304. Mailbox 304 triggers an interrupt to have Thread B 412 run in the core 212 and read the control message 404. Optionally, Thread B 412 may configure an output buffer to store and forward output data as it is generated. Thread B then retrieves input data 408 from input buffer 310 for processing. As threads A and B process input data, they respectively provide output data to the appropriate output buffer, along with a destination tag that specifies where the data is to be sent. As the threads terminated, they trigger the transmission of one or more termination messages 418 from termination message array 316. The termination messages may take the form of a control message to initiate subsequent processing by the destination to which the output data is directed.

Control message 404 is shown arriving after the processing of Thread A is substantially complete, enabling the threads to perform their processing without any preemption. In some embodiments, preemption may occasionally occur, but it may be expected to be minimized due to the operation of the messaging hardware which gathers complete data sets and control messages before alerting the processor core to the existence of said data and messages.

In some embodiments, the input buffers 308-310 are configured as first-in-first-out (FIFO) buffers. Each of the input buffers are configured to operate in the same way, thereby enabling the input data to be transferred in a manner that is independent of source or destination. This configuration relaxes the timing restrictions on control messages, enabling them to be received before, during, or after the associated data transfer. However, in some embodiments, the control and data messages 402-408 are limited to apply to one thread ahead of the current computation. Termination messages 316 can be used by the messaging hardware to enforce this restriction.

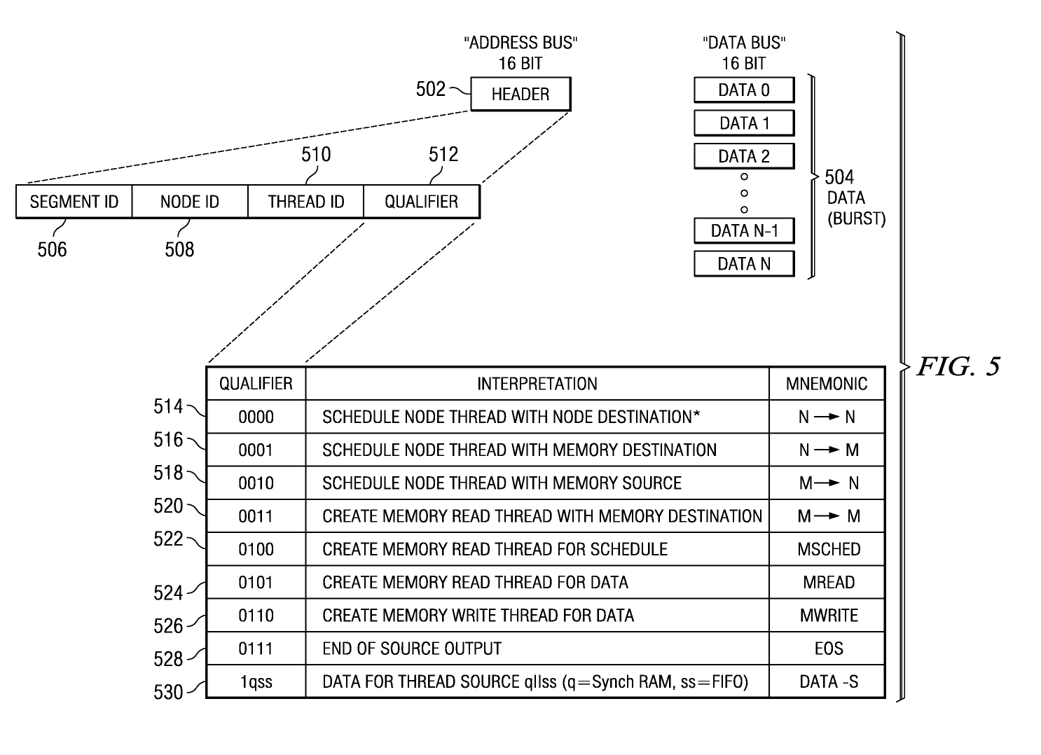

FIG. 5 shows an overview of an illustrative interconnect communication protocol. Messages (both control and data transfer messages) are transmitted over the interconnect as packets having a header 502 followed by a payload or “data burst” 504. In the illustrative protocol, the header includes four fields: a 4-bit Segment ID 506, a 4-bit Node ID 508, a 4-bit Thread ID 510, and a 4-bit Qualifier 512. The Segment ID 506 identifies which sub-cluster the message should be sent to. The Node ID 508 identifies which node 202 within the segment is the intended recipient of the message. In this illustrative embodiment, there are a maximum of 15 segments with a maximum of 15 nodes per segment. Not all nodes within a segment are necessarily tied to a global interconnect; however, each node within the segment is able to at least indirectly access every other node point-to-point connections. Two of the Segment ID's 506 and Node ID's 508 may be reserved for broadcast and multicast. A message to Segment 0 is accepted by all segments. A message to Node 0 within a segment is accepted by all nodes in the segment. For example, a message to Segment 0 and Node 0 is accepted by all nodes in the system. A message to Segment 0 and Node 2 is accepted by Node 2 in all segments, and a message to Segment 2 and Node 0 is accepted by all of the nodes within Segment 2.

The Thread ID 510 identifies which execution thread on the node is specifically intended to receive the message. Each core preferably supports the sharing of hardware resources by multiple physical or logical threads. At least in theory, each thread executes independently of all other threads on a core. To support this independence while sharing resources, each thread has a corresponding set of internal register values that are moved in and out of the hardware registers when different threads become active. Physical threads are threads in which the register switching is performed by hardware, whereas logical threads can be physical threads or threads in which software carries out the transfer of register values. Typically, each physical thread can support multiple logical threads.

In the preferred embodiment, threads corresponding to thread IDs 1-7 and 9-15 are for general usage, while thread IDs 0 and 8 are reserved for system messages (e.g., to configure the nodes). Thread ID 1 identifies the same logical thread as Thread ID 9, Thread ID 2 is the same thread as Thread ID 10, and so on. The most significant bit of the thread ID 510 is used for selecting between mailbox 306 and mailbox 304 for control messages.

In the illustrative embodiments, the qualifier field 512 has different meanings depending on whether the thread ID specifies a general usage thread or a system thread. For system thread IDs 0 and 8, the qualifier field values specify one of various available sources for instruction code for the various execution threads, whether the instruction code loading is to occur under control of the local core or to be performed automatically by the messaging hardware, and whether the currently active threads are to finish the current tasks or be preempted and reset. The instruction code is loaded into instruction memory via FIFO 0 of input buffer 308, and it may be supplied to input buffer 308 from a control node (a node responsible for coordinating the operations of all the other nodes) or retrieved by the local core from a memory node. The qualifier field values may further specify that new termination messages are to be loaded into the termination message array, and may specify that memory mapped registers controlling the operation of the messaging hardware are to be populated with configuration values from the control node.

FIG. 5 shows a qualifier value table with associated meanings for the general usage thread IDs. Qualifier values having a most-significant bit of 0 indicate that the message is scheduling message to initiate execution of a thread. The remaining qualifier value bits indicate the type of thread being scheduled, as characterized by its source of input data and its destination of output data. For instance, a qualifier field value of 0000 specifies the scheduling of a node thread with a node source and destination as indicated by row 514. Qualifier field value 0001 specifies the scheduling of a node thread with a node source and a memory destination as indicated by row 516. Qualifier field value 0010 specifies the scheduling of a node thread with a memory source and a node destination as indicated by row 518. Qualifier field value 0011 specifies the scheduling of a node thread with a memory source and a memory destination as indicated by row 520. Qualifier field value 0111 indicates that the message is an “End of Source” message (i.e., a termination message indicating the end of a data stream) as indicated by row 528. Qualifier field values having a most-significant bit of 1 indicate that the control message is associated with data stored in a memory buffer and FIFO specified by the remaining bits of the qualified field value, as indicated by row 530.

When a control message with a qualifier field value of 0000 is received, the messaging hardware schedules a node-to-node thread. The address and data form a single scheduling unit that is placed in one of the node's mailboxes 304-306. The message header 502 indicates which thread to schedule on the local node, while the payload 504 carries information for the node-to-node outputs. This information identifies the destination node and thread, and an identifier to tag the output data 414 so that the destination node receiving the data can distinguish this data from its other inputs. As the scheduled thread produces output data 414, this information is used to create “Data from Source S” messages to the destination node. The node-to-node scheduling message 514 can also indicate that the output data 414 is to be sent to memory in addition to the destination node. (In some embodiments, the payload includes optional fields to further qualify the message header information. These optional fields may include a source ID field and an additional destination field.) The remainder of this message data contains information that will be used to create a memory write thread when the local thread begins execution. As the thread produces output data 414, the messaging hardware sends the data twice, once with a memory-node ID and once with a hardware-node ID. With this protocol, the memory node is not responsible for forwarding data to the second hardware node, thus eliminating data dependency checking between read and write threads.

When a control message with a qualifier field value of 0001 is received, the messaging hardware schedules a node-to-memory thread. The payload of the control message specifies a destination memory node, with (e.g.) a 32-bit start address to which output data should be sent. When the thread begins execution, it employs this information to send a “Create Memory Write Thread” message to the destination memory node, and as the scheduled thread produces output data 414, this information is used to create “Data from Source S” messages to the memory node. Conversely, when a control message with a qualifier field value of 0010 is received, the messaging hardware schedules a memory-to-node thread. The control message payload specifies a source memory node, with (e.g.) a 32-bit start address from which input data should be obtained. When the thread begins execution, this information is used to send a “Create Memory Read Thread” to the source memory node. As the memory thread produces output data 414 and sends it to the current node using “Data from Source S” messages to the scheduled thread. The Source ID is used to distinguish this input. The memory Thread ID 510 can also be used to distinguish pre-configured information such as address stride, direction, priority, etc. This node-to-node outputs information identifies the destination node and thread, and an identifier to tag the output data so that the destination node 202 can distinguish it from other inputs.

When a control message with a qualifier field value of 0011 is received, the messaging hardware schedules a memory-to-memory thread. This type of control message can be used to copy data from one memory to another (e.g. system memory to a local, shared memory) or from one address to another within the same memory. The control message payload specifies source and destination addresses and the size of the block to copy. The target memory node creates the write thread, then creates a read thread either locally or by sending a “Create Read Thread” to the source memory node. The payload further specifies a write-thread ID to be used in “Data from Source” messages to be sent from the reading thread.

When a control message with a qualifier field value of 0100 is received, the messaging hardware creates a memory schedule read thread. The control message payload carries the starting read address and the length of the read (in message units, or 16 bits). The messaging hardware arbitrates for access to the local memory array, reads and sends the messages stored there. The stored messages can be of any type described in this document—for example, they can be control messages to schedule any number of node-to-node threads, or they may be “Data from Source” messages or configuration messages to set operating parameters in memory mapped hardware registers. The source memory node parses the messages to determine how and where the individual messages in the sequence should be sent. Once the indicated length of data has been sent, the memory node terminates the read thread. In some embodiments, the memory nodes omit the “End of Source Output” message that would otherwise be used to indicate the termination of a thread.

When a control message with a qualifier field value of 0101 is received, the messaging hardware creates a memory data read thread. The actions associated with a memory data read thread are much like the memory schedule read thread, but the retrieved data is treated as raw data and packaged by the source memory node into “Data from Source” messages with pre-pended message headers having the Seg ID 506, Node ID 508, Thread ID 510, and Source ID as specified by the original control message payload. Once the indicated length of data has been sent, the source memory node terminates the read thread and sends an “End of Source” message.

When a control message with a qualifier field value of 0110 is received, the messaging hardware creates a memory write thread. The control message payload carries the starting write address. As “Data from Source” messages are received, the current node writes the data starting at the indicated address. An “End of Source” message with the appropriate thread IDs, terminates the write thread. When a control message with a qualifier field value of 0111 is received, the control message payload carries the Source ID of the thread that is terminating data production.

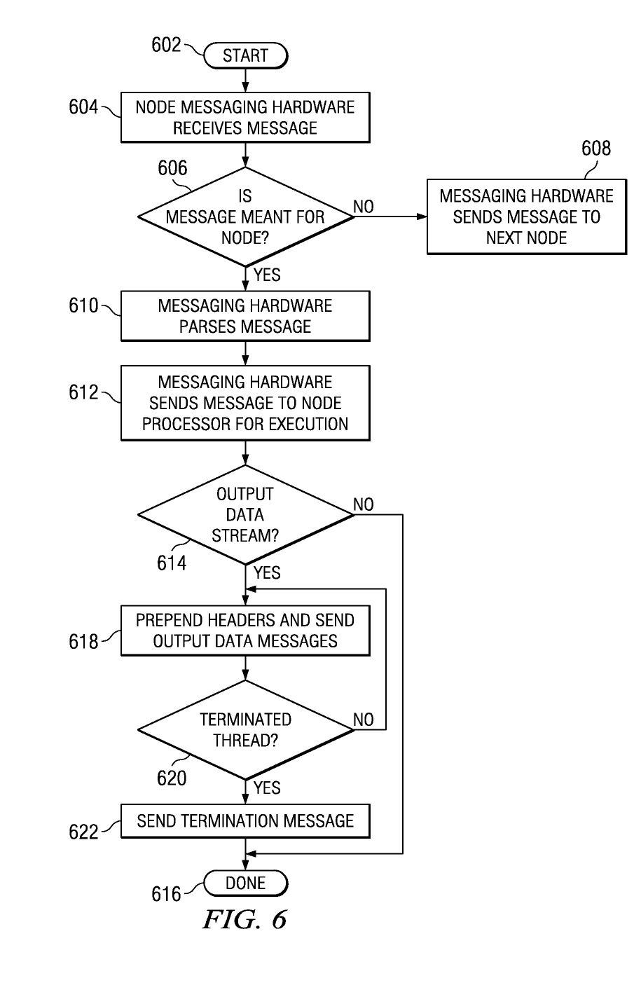

FIG. 6 is a flowchart of an illustrative communication method that may be implemented by the messaging hardware. The messaging hardware is initially in a wait state 602. In block 604, the node messaging hardware 210 receives a message. As the messaging hardware is receiving a message, the local core continues operating without interruption. In block 606, the messaging hardware 210 determines from the message header whether the message is meant for the node that has received the message. As shown in block 608, the messaging hardware forwards the message to another node if appropriate. However, if the message is meant for the current node, then the messaging hardware 210 parses the message in block 610. The parsing operation may include extracting information from the payload to determine source information for incoming messages, and destination information for output data that will result from processing of the incoming messages. In block 612, the messaging hardware 210 forwards the message to the core 212 for execution. Hence, the message has been fully received and made accessible before the core 212 is notified of the message.

In block 614 the messaging hardware determines whether an output data stream is being produced from the processing of the incoming data. If not, the messaging hardware concludes operations in block 616 until another message is received. If an output data stream is produced, then in block 618, the messaging hardware prepends message headers with the appropriate destination information and sends a sequence of messages to the appropriate node. After each message is sent, the messaging hardware checks in block 620 to determine if the thread has terminated. If so, the messaging hardware sends a termination message in block 622.

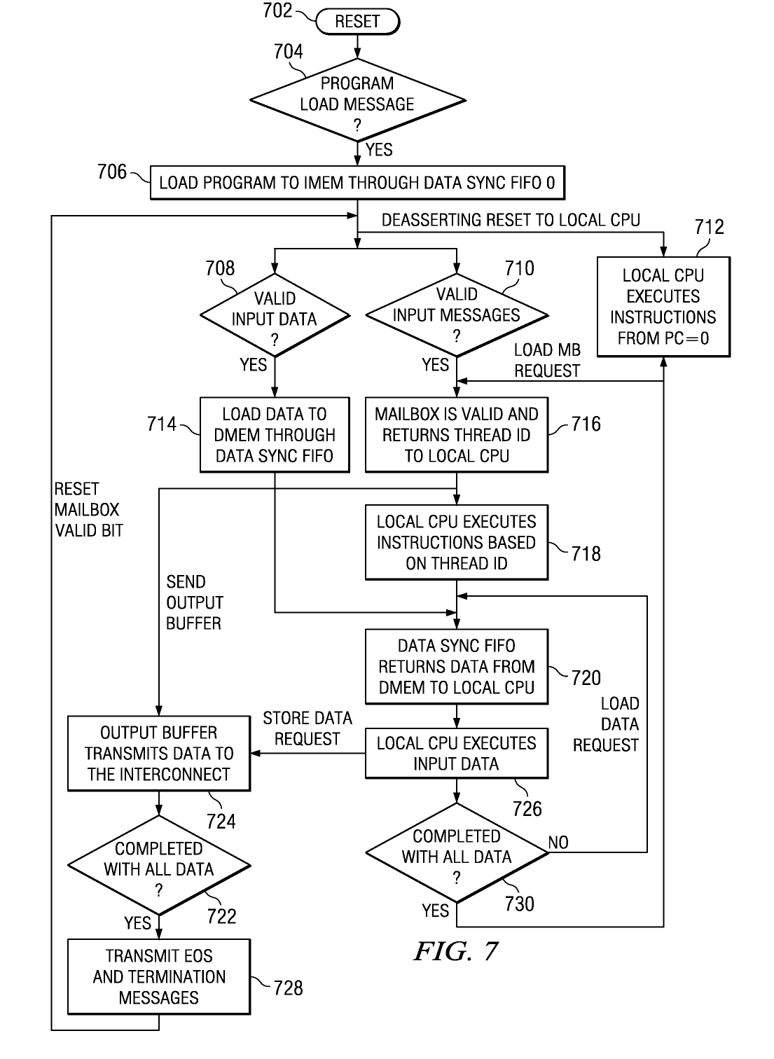

FIG. 7 shows a flowchart of an illustrative message processing method that may be implemented by the messaging hardware. The method may be divided into two phases: initialization (including reconfiguration) and normal message/data transmission. The initialization phase is represented by blocks 702-710 in FIG. 7. In block 702, mailbox 304 or 306, receives a “Schedule N to N Thread” or “Schedule M to N Thread” message with the thread ID set to 0 or 8 for initialization. (The message type is verified in block 704, and if it is not of the expected type, the messing hardware returns to block 702.) A node-to-node thread message 514 specifies that the control core will send the initialization program in the form of a “Data From Source” message. A memory-to-node thread message 516 enables the program to be loaded directly from memory. In response to receiving such a message, the messaging hardware initializes the memory buffer 308, setting the write pointer for FIFO 0 to the starting address of the local instruction memory. (Preferably, the messaging hardware allows an input FIFO to be mapped to any location in local memory.) In block 706, the incoming program data is loaded into the instruction memory. When the “End of Source” message is received, the receiving mailbox wakes up the local core 212 by deasserting the reset signal, and begins monitoring for data transfer messages in block 708 and control messages in block 710. Meanwhile, the local core begins executing the program code from the instruction memory. This includes initialization instructions to set up the memory mapped registers for the mailboxes 304306, memory buffers 308-310, and output buffers 314, depending on the configuration loaded.

The normal transmission phase begins in blocks 708-710 where the messaging hardware monitors the incoming interconnects for control and data messages. Once a valid incoming message is detected, it is processed. For data transfer messages, the messaging hardware stores the data in an input buffer in block 714. In block 716, the local core executes a load from the mailboxes—an operation which stalls until a valid control message is available. (If both mailboxes contain valid messages, the message which arrived first is loaded). In block 718, the local core initiates the appropriate thread based on the thread ID of the loaded message, and in block 720, the local core retrieves the data from the input buffer for processing. If the input buffer is empty, the data retrieval operation stalls until the data has been received.

If the control message loaded by the local core in block 716 involves memory access, the messaging hardware sends a “Create Memory Read Thread” or “Create Memory Write Thread” message to the appropriate memory node. If the control message indicates that an output data stream will be produces, the messaging hardware further sets up the termination tags and output protocol for the output buffer. Thereafter, the messaging hardware returns to its monitoring state.

In block 726 the local core processes the data, periodically storing output data to the output buffer, from where it is packaged into a message and transmitted in block 724. In block 730, the local core determines whether all of the input data has been processed, and if not, it returns to block 720 to retrieve additional input data. Otherwise, the local core returns to block 716 to await further control messages. In block 722, the messaging hardware determines whether the output data stream is complete (e.g., whether the local core is accessing the mailboxes for new messages), and if so, it transmits an “End of Source” message and any other appropriate termination messages in block 728.

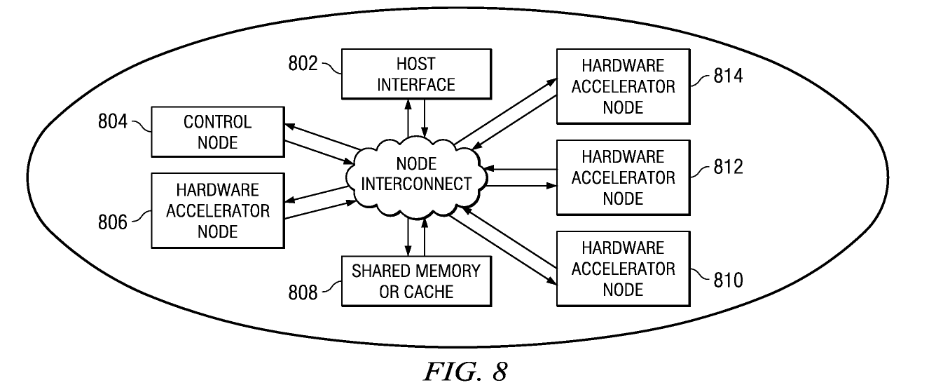

FIG. 8 is an illustrative embodiment of a system having a memory node that is shared by multiple other nodes. This embodiment shows how a series of homogeneous or heterogeneous nodes may share a memory 808. A control node 804 is coupled to numerous other nodes via a node interconnect. The other nodes shown include a host interface node 802 and Hardware Accelerator nodes, 806, 810-814. The node interconnect may be employ any suitable physical transport protocol, including OCP, AXI, etc. In addition to the star-topology illustrated here, other suitable topologies include a client-server topology, a data-parallel topology, a pipelined topology, a streaming topology, a grid or hypercube topology, or a custom topology based on the overall system function. Messages sent from the control node 804 may be directed to any other node in system using the messaging protocol described above.

It is noted here that a standardized messaging hardware “wrapper” such as that disclosed herein creates several potential advantages. It becomes possible to partition the various functions of a complex integrated circuit into modular, specialized nodes that transfer data using packet-based interconnect signaling. Such signaling greatly relaxes the timing constraints normally associated with shared buses and long wires, enabling greater placement freedom. The use of specialized nodes enables the simplification of circuit complexity for given performance requirements. Moreover, the implementation details of the specialized processing cores are shielded from the rest of the system by the dedicated messaging hardware. This enables individual module designs to be created and refined independently of the other circuit modules, significantly reducing development and testing times. Thus individual modules can be initially coded and simulated as software, quickly manufactured as low-complexity general purpose processor cores having integrated firmware, and later refined as needed to meet power and performance constraints. Functional verification is also simplified through the use of the modular designs. Yet another potential advantage arises from the ease with which the specialized modules can be duplicated and coupled into the circuit to provide a greater degree of hardware parallelism.

It is further noted that these potential advantages are made attainable with a messaging hardware wrapper that does not demand interrupt or pre-emption support. Moreover, the messaging hardware insulates the core from messaging protocols, and does not itself introduce any bottlenecks to the data flow or processing operations.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A system comprising a plurality of processing nodes integrated on a semiconductor chip, each processing node including:
a processing core; and
messaging hardware that includes:
at least one input data buffer to receive data transfer messages via an interconnect;
at least one output data buffer to send output data via an interconnect; and
at least one mailbox that receives control messages specifying an output data destination, wherein in response to a control message the mailbox initiates operation of the processing core to process data from the input data buffer and provide output data to the output data buffer, and wherein the mailbox configures the output data buffer to send the output data to said output data destination.

2. The system of claim 1, wherein processing core has multiple threads, and wherein the mailbox initiates operation of a thread specified by the control message.

3. The system of claim 2, wherein the processing core completes the operations initiated by the control message before initiating operations in response to a subsequent control message.

4. The system of claim 1, wherein at least one of the plurality of processing nodes has a processing core that is heterogeneous with respect to another processing node.

5. The system of claim 4, further comprising a shared memory node integrated on the shared semiconductor chip, the shared memory node storing program instructions for heterogeneous processing nodes.

6. The system of claim 5, wherein the shared memory node includes:
a memory array; and
messaging hardware that initiates a thread to access memory in response to a control message from one of the plurality of processing nodes.

7. The system of claim 6, further comprising a network of node interconnections to interconnect the plurality of processing nodes and the shared memory node.

8. The system of claim 7, wherein the network of node interconnections comprises point-to-point connections that transport message packets.

9. The system of claim 7, wherein the network is a packet-switched network having a star topology.

10. A data processing method comprising:
providing a shared memory node on a semiconductor chip; and
providing heterogeneous processing nodes on the semiconductor chip,
wherein the heterogeneous processing nodes each include messaging hardware that communicate with the shared memory node and other processing nodes using messages,
wherein each message includes a thread identifier that indicates a thread to be initiated on a destination node once the message has been received.

11. The method of claim 10 wherein the shared memory node stores program instructions for nodes having different instruction sets.

12. The method of claim 11, further comprising:
receiving at each of the processing nodes at least one control message that causes that processing node to retrieve program instructions from the shared memory node for each of multiple threads on that processing node.

13. The method of claim 12, further comprising:
receiving by at least one of the processing nodes a data transfer message and a control message, wherein the control message causes the messaging hardware to initiate a thread specified by the control message, and wherein the thread processes the data from the data transfer message to produce output data.

14. The method of claim 13, wherein the control message further causes the messaging hardware to prepare an output buffer to send the output data to a destination specified by the control message.

15. The method of claim 14, wherein the output buffer sends the output data as a sequence of data transfer messages each having a header, and wherein the output buffer automatically appends a termination message once the thread finishes processing.

16. The method of claim 13, wherein the messaging hardware enables a local core to complete a previous task before initiating said thread in response to the control message.

17. The method of claim 10, wherein the messaging hardware includes:
data buffers that receive data transfer messages via an interconnect;
at least one output data buffer that sends output data via an interconnect; and
mailboxes that receive control messages specifying an output data destination.

18. The method of claim 10, further comprising:
transporting messages between processing nodes using an interconnection network having a star configuration.

19. The method of claim 10, further comprising:
transporting messages between processing nodes using an interconnection network having a pipeline configuration.
